(19) United States
(12) Patent Application Publication
(10) Pub. No.: US 2015/0203802 A1
(43) Pub. Date: Jul. 23, 2015

(54) METHOD AND ARRANGEMENT FOR HEATING OF LIQUIDS VIA RF ENERGY

(71) Applicants: Keith Alan Mort, Fletcher, NC (US); Chad Slagle, Black Mountain, NC (US)

(72) Inventors: Keith Alan Mort, Fletcher, NC (US); Chad Slagle, Black Mountain, NC (US)

(21) Appl. No.: 14/160,017

(22) Filed: Jan. 21, 2014

(51) Int. Cl. C12G 3/12; H05B 6/68; H05B 6/80

(52) U.S. Cl. CPC C12G 3/12; H05B 6/802; H05B 6/68

(57) ABSTRACT

The present invention provides a method for assisting in the distillation or heating of a liquid commodity and the method includes providing a liquid commodity and irradiating the liquid commodity directly with radio frequency energy. The method is useful for generating vapor, be it vapor in the form of by-products to be further handled and/or disposed of, or vapor that is to be subsequently cooled in a condensing step to return to a liquid state.

### BACKGROUND OF THE INVENTION

According to U.S. Pat. No. 2,807,547 to Nickol, one known method of producing whisky includes preparing a barrel of white oak wood by charring the interior to an extent and depth established by practice. An aqueous—alcohol distillate (so-called high wine) derived from the fermentation of a cereal mash is introduced into the barrel which is then tightly sealed and held preferably under prescribed conditions of temperature and humidity for a period of years. During this time progressive changes occur, both in the extraction of certain constituents from the charred wood and in the reaction of other constituents originally present in the high wines, either with themselves or with constituents derived from the wood. Broadly speaking, the constituents which characterize the final product, in addition to the base of ethyl alcohol, are organic acids, aldehydes, fusel oil, and organic esters together with coloring matter.

One disadvantage of the aging process, according to U.S. Pat. No. 2,807,547 to Nickol, is that the barrels can only be used once for the production of a satisfactory grade of whisky which adds substantially to the expense, and the cost of handling liquids in containers of such relatively small size as compared to those used in other industries which handle liquids, is relatively excessive. According to U.S. Pat. No. 2,807,547 to Nickol, attempts have been made to dispense with the use of the charred oak barrels by storing the high wines in containers of stainless steel for example, and adding to the high wines so stored an amount of charred oak chips corresponding in ratio to those which would be presented to the high wines in barrel-aging practice, or alternatively to add to the high wines so stored a corresponding amount of the extractives obtained by the aqueous ethyl alcohol extraction of charred wood chips. But, notes U.S. Pat. No. 2,807,547 to Nickol, these attempts have not been successful because, since the whisky is lacking certain essential flavoring constituents if an attempt is made to correct this condition by the use of a larger amount of charred chips or extractives derived therefrom, the resulting whisky is, according to U.S. Pat. No. 2,807,547 to Nickol, over-balanced in certain other constituents and is therefore of inferior grade.

U.S. Pat. No. 2,807,547 to Nickol proposes a distillation method via which it is no longer necessary to use wood barrels, and the aging can be carried out in drums of stainless steel or a similar material which can be re-used indefinitely or alternatively can be carried out in large vats or tanks of the same or similar material, with corresponding economies in storage and in transfer.

While U.S. Pat. No. 2,807,547 to Nickol points out the virtues of large scale handling of liquids treated in a distillation process, with such large scale handling including the use of drums or tanks each significantly larger than individual aging barrels, the distilling process still requires heating of the liquid preparation to produce vapor that can subsequently be cooled or condensed into a liquid state. The heating of large volume drums or tanks is often been performed via gas-fueled heating elements which heat the drums or tanks themselves to thereby heat the liquid preparation retained in the drum or tank. This indirect heating approach thus leads to less than optimal energy conversion of the heating energy (BTU) of the gas-fuel combustion into thermal heating of the liquid contents of the drums or tanks, as the drums or tanks themselves heat up and do not completely transfer all of their heat content to the liquid contents. Also, the gas-fuel combustion approach can lead to scorching of the liquid contents, wherein some portions of the liquid are subjected to over-heating.

Accordingly, there is room for improvement in the heating and thermal treatment of liquids and, in particular, liquids undergoing heating for the purpose of generating vapor, be it vapor in the form of by-products to be further handled and/or disposed of, or vapor that is to be subsequently cooled in a condensing step to return to a liquid state.

### SUMMARY OF THE INVENTION

One object of the present invention is to provide a method for assisting in the distillation or heating of a liquid commodity, wherein the method includes providing a liquid commodity and radiating the liquid commodity directly with radio frequency energy.

A further object of the present invention is to provide an apparatus for assisting in the distillation or heating of liquid commodities. The apparatus includes a vessel for retaining a liquid commodity and a device for radiating the liquid commodity directly with radio frequency energy. According to several features of this one aspect of the present invention, the vessel is a load cell sub-assembly and includes an infeed from receiving a supply of liquid from a distillation tank or cook tank. The load cell sub-assembly is operable to receive liquid from a distillation tank or cook tank and to heat the liquid via radio frequency energy to generate vapor, and the load cell sub-assembly including sensors in communication with a control device via one or more analog, digital, fiber optic, or infrared connections. The sensors operate to provide signals to the control device indicating sensed parameters of the process such that the control device can automatically, or with user input, control and adjust the radio frequency power output.

An additional object of the present invention is to provide consumable liquid product formed by the process of providing a liquid commodity and radiating the liquid commodity directly with radio frequency energy.

### BRIEF DESCRIPTION OF THE DRAWINGS

For a more complete understanding of the embodiments of the present invention, reference is now made to the following descriptions taken in connection with the accompanying drawings in which:

FIG. 1 is a schematic view of one embodiment of a liquid treatment arrangement in accordance with the present invention.

FIG. 2 is a schematic view of the liquid treatment arrangement in combination with another processing component as a combined process sub-assembly for supplying the in-process vapor product needed for a distillation process;

FIG. 3 is a schematic view of an exemplary load cell sub-assembly for use in connection with the liquid treatment arrangement of the present invention; and

FIG. 4 is an enlarged front sectional view of the exemplary load cell sub-assembly shown in FIG. 3;

FIG. 5 is a top perspective view in partial section of a further embodiment of a liquid treatment arrangement in accordance with the present invention

FIG. 6 is a schematic front elevational view of a resonance generator assembly;

FIG. 7 is a schematic top perspective view of the wood-sided liquid retainer and the jacket structure; and

FIG. 8 is a partial sectional top perspective view of a transducer suitable for use in the liquid treatment method of the present invention.

### DETAILED DESCRIPTION OF AN EMBODIMENT

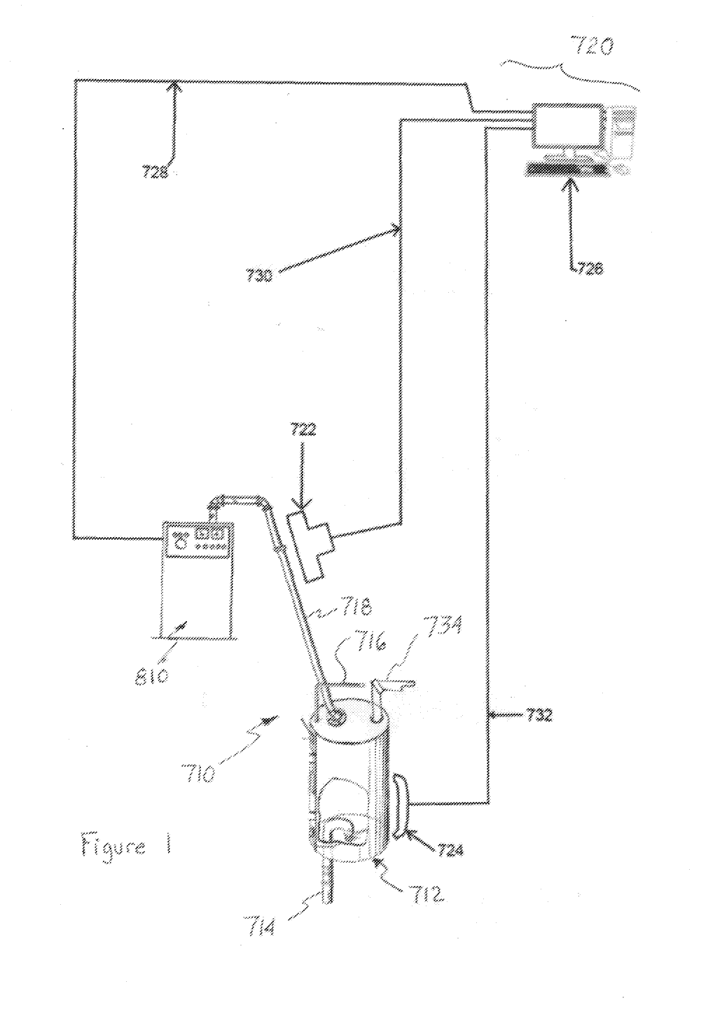

Reference is now had to FIG. 1, which is a schematic view of one embodiment of a liquid treatment arrangement in accordance with the present invention. The liquid treatment arrangement, generally designated as the liquid treatment arrangement 710, is particularly advantageous for treating a liquid to create vapor, which is thereafter handled according to known conventional methods so as to yield a distilled product and so the deployment of the liquid treatment arrangement 710 provides a distillation process that is an alternative to common distillation and bulk liquid heating processes. The liquid treatment arrangement 710 includes a vessel 712 for retaining a treatment feedstock 714, which may be comprised exclusively of a liquid or may be a liquid-solids mixture—i.e., a liquid having solids particles in suspension. The treatment feedstock 714 is retained in the vessel 712 for the purpose of being subjected to a treatment that includes the application of radio frequency energy (RF energy) to the treatment feedstock 714. The application of RF energy to the treatment feedstock 714 may be controlled to cause a number of selected treatment outcomes such as, for example, (a) an elevation of the treatment feedstock 714 to a predetermined higher temperature, (b) a phase change of the treatment feedstock 714 whereby evaporation of the treatment feedstock 714 occurs (so that the evaporated liquid or liquid/solids portion undergoes a phase change to become a gas—i.e., vapor), or (c) an improved mixing or dissolution of liquid components or solids components of the treatment feedstock 714.

The vessel 712 is representatively shown as being configured as a single wall cylindrical kettle and includes a feed inlet pipe 714 having an external open end communicated with a downstream replenishment source (not shown) from which fresh dosages of the treatment feedstock 714 can be supplied to the vessel 712. The feed inlet pipe 714 extends through a sealed aperture in the floor of the vessel 712 and has an outlet open end that is suitably configured to preclude back flow of the treatment feedstock 714 out of the vessel 712 (i.e., the outlet open end may be provided with a one way valve). The vessel 712 includes a pressure relief conduit 716 communicated with the interior of the vessel 712 via the top cover of the vessel 712 and the pressure relief conduit 716 is provided with a remotely controlled end cap that can be selectively opened or dosed to thereby regulate or control a pressure condition within the vessel 712.

The top cover of the vessel 712 is also the location at which an output end of a waveguide 718 is secured. This output end of the waveguide 718 may be, for example, a sight glass that is fixedly secured to the top cover of the vessel 712 and the sight glass is comprised of a transparent glass assembly that is appropriately heat-tempered—i.e., a quartz window. An inlet end of the waveguide 718 is communicated with a microwave source 810.

The microwave source 810 applies microwave radiation to the treatment feedstock 714 in the vessel 712 via the waveguide 716. It is to be understood that the microwave source 810 may be configured as any suitable device operable to provide RF energy at 915 MHz that is communicated via the waveguide 718 to the treatment feedstock 714 in the vessel 712 and so the microwave source 810 may accordingly be configured as a magnetron operating at 915 MHz operating at, for example, 10-200 kW, and which can be tuned to provide a desired penetration depth and/or a desired power availability. It is believed that the deployment of such a magnetron operating at 915 MHz will provide benefits flowing from certain activities that will occur as the treatment feedstock 714 is radiated. In this connection, although the patentability of the present invention is not in any way to be constrained by a particular theory of operation, it is believed that a magnetron operating at 915 MHz will provide benefits flowing from microwave excitation of water molecules inside organic material in the treatment feedstock 714, such microwave excitation being by caused by subjecting the treatment feedstock 714 to radio frequency waves at 915 MHz. The polar water molecules in the treatment feedstock 714 endeavor to align themselves with an oscillating electric field at a frequency of 915 MHz or approximately every nanosecond. In view of the fact that the molecules cannot change their alignment synchronously with the changing electric field, the resistance of the molecules to change gives rise to heat. Also, the treatment feedstock 714 undergoes a phase change to be released as water vapor or steam. The heat conducted through the treatment feedstock 714 and capillary action within the material converts surface moisture to water vapor.

This efficient release of moisture from organic material of the treatment feedstock 714 reduces energy costs and increases throughput. In the case of non-polar molecules, the applied microwave energy results in dielectric polarization. Since a phase difference occurs between the applied electric field and the energy absorbed within the treatment feedstock 714, the losses within the treatment feedstock 714 act as a resistance, resulting in additional heat generated within the treatment feedstock 714. To the extent that a portion of the treatment feedstock 714 is comprised, for example, of organic material in the form of water, the heat generated from dipolar and dielectric heating of the treatment feedstock 714 is sufficient to effectively cause bond dissociation, generation of free radicals and hydrogen, resulting in the volumetric reduction of the treatment feedstock 714 and formation of vapor.

The microwave source 810 is operatively connected to a feedback responsive arrangement 720 that functions to gather feedback about the process of applying microwave radiation to the treatment feedstock 714 so that the microwave source 810 can be dynamically controlled to vary or change selected properties of the microwave radiation applied to the treatment feedstock 714 in the vessel 712. Such feedback can relate to any portion of the overall process via which the treatment feedstock 714 contributes to, or is transformed, into a final product and so feedback can be gathered not only at the vessel 712 but also at any suitable locations that are upstream or downstream of the vessel 712 (upstream or downstream being understood in the sense of the process flow of the overall process). In connection with the example that the production contribution of the vessel 712 is part of an overall process resulting in a distilled product, it can be seen that feedback can be gathered about the volume or quality of vapor produced by the vessel 712 and this type of feedback can be fed back to dynamically control the microwave source 810. Moreover, such feedback can relate to indirect markers or tell-tales. For example, data concerning the build-up of pressure in the vessel 712 may be an indirect but nonetheless responsive indicator of the quality of vapor discharged from the vessel 712.

Solely for the sake of illustration, one configuration and method of operation of the feedback responsive arrangement 720 will be described in which the feedback responsive arrangement 720 is operated to obtain data concerning the build-up of pressure in the vessel 712. The feedback responsive arrangement 720 includes a direct intervention element 722, a pressure sensitive transducer 724, and a control coordinator 726 that is operatively connected with the microwave source 810 via a lead 728, operatively connected with the direct intervention element 722 via a lead 730, and operatively connected with the pressure sensitive transducer 724 via a lead 732. The control coordinator 726 controls the direct intervention element 722 to vary selected properties of the microwaves applied by the microwave source 810 in response to feedback received from the pressure sensitive transducer 724 regarding pressure in the vessel 712.

The direct intervention element 722 may be configured as a wave-based variation element that changes the characteristics or the focusing of the microwaves during their passage from the microwave source 810 to the vessel 712 and the direct intervention element 722 is exemplarily illustrated as acting on the microwaves at a location along the waveguide, which may be a conventional waveguide operating according to known waveguide operating principles. The process of varying or moderating the microwaves can be performed in a number of different manners depending upon the wavelength and power of the applied microwaves.

Microwaves can be moderated by changing the power applied to a microwave source and can also be moderated by changing the duty cycle of the microwave source. The moderation of the duty cycle is a common approach to moderating microwaves and has the benefit of being a straightforward approach. The leads 728, 730, and 732 can be configured as fiber optic conduits or wireless connections can be deployed in lieu of wired connections.

Vapor is discharged from the vessel 712 via a discharge conduit 734 having one end communicated with the top cover of the vessel and another end communicated with a vapor collection apparatus (not shown) that is part of an arrangement upstream of the vessel 712 for handling vapor according to known conventional methods so as to yield a distilled product. As noted, the deployment of the liquid treatment arrangement 710 provides a distillation process that is an alternative to common distillation and bulk liquid heating processes. Moreover, while the liquid treatment arrangement 710 may be operated in a manner to entirely supply the in-process vapor product needed for the distillation process, the liquid treatment arrangement 710 can also be operated in combination with other processing components so that this combination of the liquid treatment arrangement 710 and the other processing components together supply the in-process vapor product needed for the distillation process.

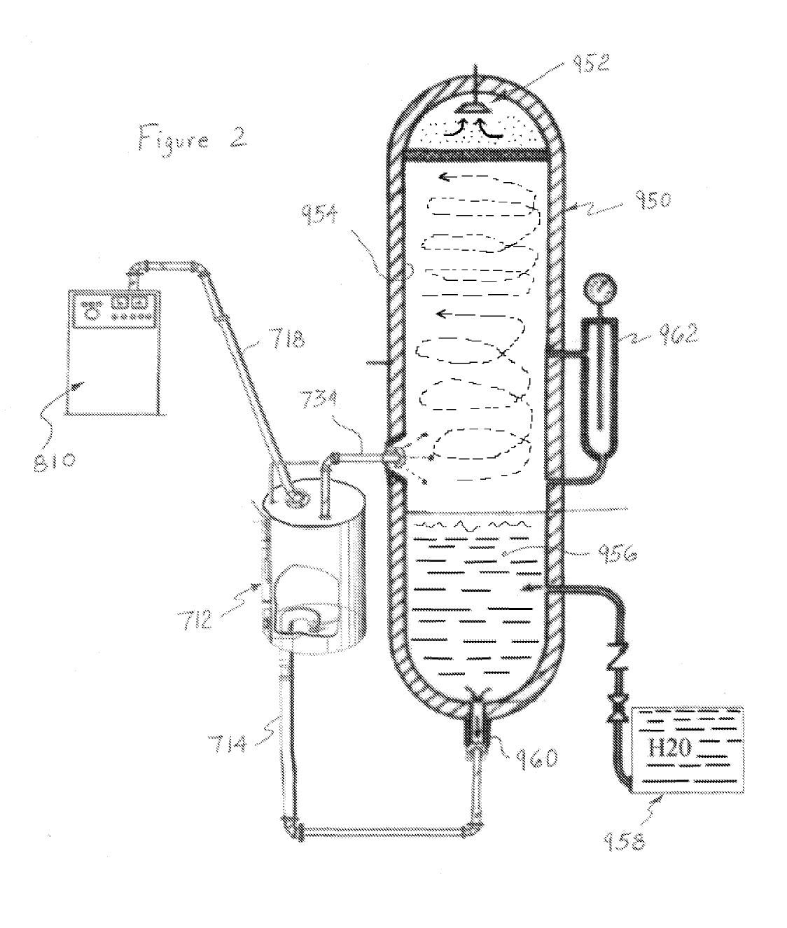

Reference is now had to FIG. 2, which is a schematic view of the liquid treatment arrangement in combination with another processing component as a combined process sub-assembly for supplying the in-process vapor product needed for a distillation process. The liquid treatment arrangement 710, which has been described with reference to FIG. 1, is operatively coupled with a vapor finish chamber assembly 950 which includes a discharge collector 952 via which vapor is further transferred to upstream components that operate according to known conventional methods so as to yield a distillated product. The outlet end of the discharge conduit 734 of the liquid treatment arrangement 710 is communicated with a dosed separation chamber 954 so that vapor supplied from the liquid treatment arrangement 710 is subjected to further heating and/or treatment before being discharged from the vapor finish chamber assembly 950. The vapor finish chamber assembly 950 includes a water feedstock portion 956 that is kept replenished with water from a water replenishment source 958 and the water feedstock portion 956 is communicated via a pipe 960 with the feed inlet conduit 714 so that the liquid treatment arrangement 710 is kept supplied with fresh water as well. Conditions in the vapor finish chamber assembly 950 such as, for example, pressure conditions, can be monitored or sensed via, for example, a pressure sensor 962, to control the operation of the vapor finish chamber assembly 950.

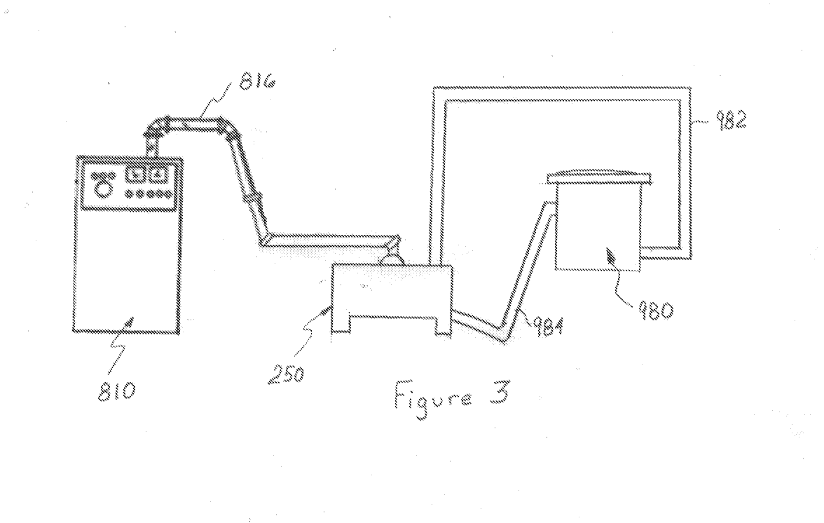

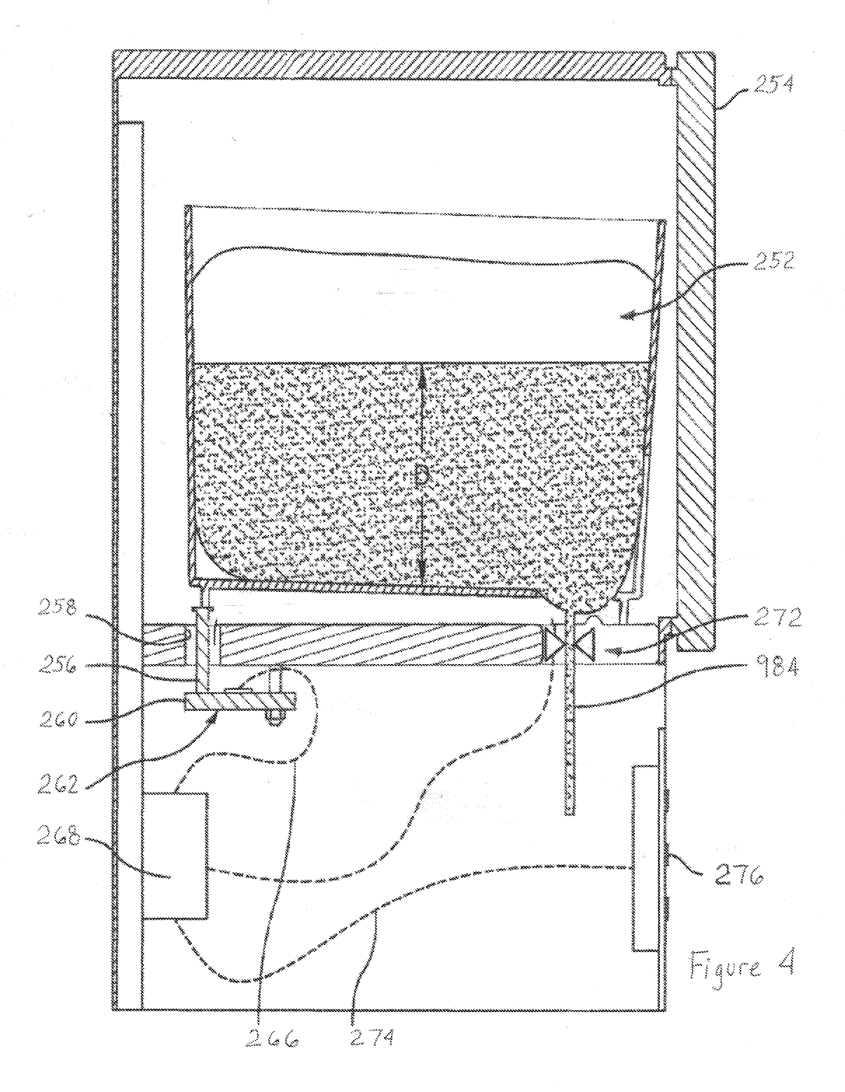

Reference is now had to FIG. 3, which is a schematic view of an exemplary load cell sub-assembly for use in connection with the liquid treatment arrangement of the present invention, and FIG. 4, which. As seen in FIGS. 3 and 4, the liquid treatment arrangement can be configured to supplement, or completely take over, the heating duties of a conventional distillation or cook tank of the type commonly found in a number of well-known distilled product production lines. The liquid treatment arrangement as shown in FIGS. 3 and 4 is configured as a re-circulation arrangement via which to-be-distilled liquid feedstock is fed from a conventional cook tank 980 along an outfeed pipe 982 to a load cell sub-assembly 250 and vapor produced by the load cell sub-assembly 250 is delivered to an upper chamber portion of the cook tank 980 that collects and discharges the collected vapor. Although not illustrated or further described herein, it is noted that the liquid treatment arrangement can alternatively be configured as a direct through-flow inline arrangement via which to-be-distilled liquid feedstock is fed directly from a feedstock source to a load cell sub-assembly and vapor produced by the load cell sub-assembly is then delivered to the upper chamber portion of the cook tank 980.

As seen in FIG. 3, the waveguide 718 is communicated with the load cell sub-assembly 250 so that liquid in the load cell sub-assembly 250 can be directly radiated via RF energy delivered through the waveguide. The load cell sub-assembly 250 is a type of load cell configuration which is to be understood as a configuration that permits one or many types of sensing or monitoring operations to be performed. Load cell configurations can be constructed in numerous geometric forms and can include secondary ports, bleed-offs, and other input and output structures. The load cell sub-assembly 250 can be configured in any suitable format so long as RF energy can be effectively introduced into the load cell sub-assembly 250 to direct radiate the liquid retained therein with RF energy.

While the load cell sub-assembly 250 may be configured as a straight pipe configuration or as a heat exchanger configuration, for the purpose of illustrating a typical load cell control parameter, the load cell sub-assembly 250 is described and illustrated herein, for the sake of simplicity, as a cyclically refillable container. As particularly seen in FIG. 4, the load cell sub-assembly 250 includes a tank 252 that is supported within a frame 254.

The vessel box 252 is preferably made of a material that is transparent to the frequency of the microwaves being generated and that is not degraded by the cyclic pressures and temperatures of the liquids being heated and in contact with its interior surface. In view of the fact that there may be cycling of relatively colder liquid and the subsequent heating of the liquid to its boiling point, the vessel box 252 should be resistant to temperature cycling. A suitable type of material can be high temperature polymer (plastic), glass, quartz, ceramic or other glass or material that fulfills these requirements. Any class of heat- and chemical-resistant glass of different compositions may be suitable depending on the needs and requirements of strength, weight, temperature cycling, smoothness, and other mechanical and reliability requirements. For example, a borosilicate type of glass that can withstand thermal shock created by sudden shifts in temperatures may be suitable. Also, borosilicate glass is advantageously “transparent” to microwave energy in that the glass does not absorb a significant amount of energy, if any, into its bonds of matter from the microwaves penetrating its matter. In the event that no separate porthole or other window is provided in the vessel box 252 for communicating the vessel box with the waveguide, it can be advantageous to configure the vessel box with a glass such as borosilicate glass, as this type of glass permits microwaves to pass through into its interior with minimal energy absorption.

The vessel box 252 is rectangular and the top edge of one axial end of the vessel box is hingedly supported on a fulcrum (not shown) formed on the frame 254. The vessel box 252 is thus able to pivot relative to the fulcrum. The opposite axial end of the vessel box 252 is supported on a vertical post 256 that extends downwardly from the underside of the vessel box 252 and through a borehole 258 formed in the frame 254. The lower end of the vertical post 256 is fixedly secured to the cantilevered end 260 of a load cell 262. The load cell 262 is secured to the frame 254 via a pair of suspension bolts 264. Accordingly, the fulcrum supports part of the weight of the vessel box 252 while the balance of the weight of the vessel box is supported by the cantilevered end 260 of the load cell 262.

The respective portion of the weight of the vessel box 252 transferred onto the load cell 262 causes the load cell 262 to deflect and a deflection of the vessel box changes the electrical resistance of a Wheatstone bridge circuit that is operatively connected to the load cell 262. In view of the fact that the deflection of the load cell 262 is proportional to the weight transferred onto the load cell by the vessel box 252 (and the liquid retained in the vessel box), a corresponding signal is generated and is transmitted via a lead 266 to a control device 268, which can be, for example, a computer chip. A lead 270 operatively connects the control device 268 to a discharge valve 272 located on the floor of the vessel box 252 so that the discharge valve 272 can be selectively operated to open and release the now-heated liquid in the vessel box 252 into a return conduit 984 that carries the liquid to the cook tank 980. A lead 274 operatively connects the control device 268 to a display panel 276 which can be programmed to provide real-time displays of the operation of the load cell sub-assembly 250.

The load cell sub-assembly is thus operable to receive liquid from a distillation tank or cook tank and to heat the liquid via radio frequency energy to generate vapor. The load cell sub-assembly may be optionally provided with sensors in communication with a control device via one or more analog, digital, fiber optic, or infrared connections and the sensors can be configured to provide signals to the control device indicating sensed parameters of the process such that the control device can automatically or with user input control and adjust the radio frequency power output.

It is well known that it is possible to produce alcoholic beverages via a process that includes the steps of: (1) producing ethanol by fermentation of sugars, grains, juices, or other vegetables or fruits; (2) distilling the product of fermentation at elevated temperatures to produce ethanolic spirits; and (3) aging the ethanolic spirits until the beverage exhibits the particular flavor, sensory, and transparency or opaqueness characteristics that are desired. Historically, this third step, the aging process, has involved storing the ethanolic spirit in wooden casks or barrels. Changes in the flavor, aroma, and color of the ethanolic spirit during the aging process occur as a result of the chemical interaction of the ethanol, water, and essential oils in the spirit, with each other, and with additional flavoring agents that are absorbed from the wood of the container. This process may take weeks, months, or years. Beverages produced in this manner include Scotch, Irish, bourbon, rye, Canadian, and Australian whiskeys, rum, brandy, armagnac, cognac, many wines, and the like. In the process of maturing or aging distillates, the distillates extract from the oak wood barrels tanning agents, lignins and hemicellulose. Typically, a dry oakwood contains about 45% cellulose, 25% hemicellulose, about 23% lignin, and up to about 15% extract substances with tanning agents. It is known that in producing alcoholic liquids such as wines obtained by fermentation of grape-musts, different types of fruit, cereals and other products, an aging step is often provided. In which the fermented product is allowed to stand in appropriate vessels, in particular casks or bottles, where it undergoes a slow maturing process intended for improving and refining its organoleptic properties.

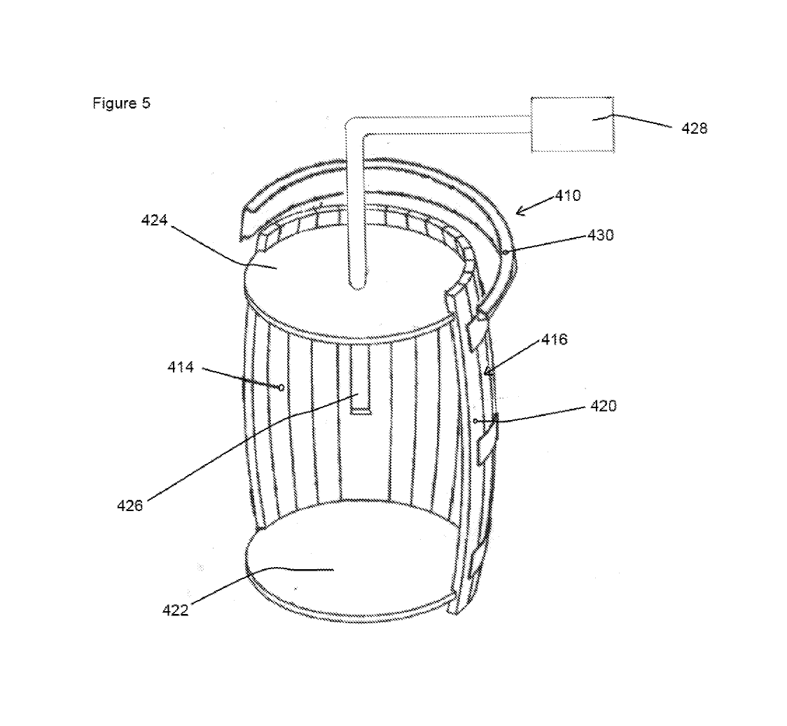

Reference is now had to FIG. 5, which is a top perspective view in partial section of a further embodiment of a liquid treatment arrangement in accordance with the present invention. A vessel assembly 410 for retaining a treatment feedstock 414 includes a wood-sided liquid retainer 416 and an RF energy delivery sub-assembly 418. The size, shape, type of wood, and wood surface characteristics of the wood-sided liquid retainer 416 can be selected as a function of the liquid treatment scenario.

The wood-sided liquid retainer 416 is generally barrel shaped in that it is comprised of a substantially tubular-shaped side wall 420, a disk-shaped bottom cap 422, and a disk-shaped top cap 424. The wood-sided liquid retainer 416 can alternatively have a different overall shape, such as, for example, a parallelepiped shape or a cylindrical shape. The wood-sided liquid retainer 416 retains the treatment feedstock 414 for the duration of an accelerated aging process or, alternatively, may retain the treatment feedstock 414 for the duration of a hybrid accelerated aging process/relatively less accelerated aging process. The RF energy delivery assembly 418 delivers RF energy into the wood-sided liquid retainer 416 so that the treatment feedstock 414 undergoes an accelerated aging process. This interaction of treatment feedstock 414 with the wood comprised in the wood-sided liquid retainer 416 can be enhanced or controlled in any suitable manner such as via known methods enhancing or controlling the interaction of a liquid feedstock with a wood-comprising vessel (i.e., storage of the wood-sided liquid retainer 416 in a temperature controlled environment for a specified duration; the addition of a flavorant or chemical breakdown agent, etc.). The addition of a flavorant may include, for example, a variety of sugar-rich syrups, such as natural or artificial honey, natural or artificial syrup, or the like.

The relatively less accelerated aging process is a process that brings about aging of the treatment feedstock 414 at a rate less than the rate of aging of the treatment feedstock 414 when subjected to RF energy delivered by the RF energy delivery assembly 418. In the event that the treatment feedstock 414 is subjected to an accelerated aging process and also subjected to a relatively less accelerated aging process (i.e., a hybrid process), the treatment feedstock 414 is retained in the wood-sided liquid retainer 416 and aging of the treatment feedstock 414 is produced via interaction of the treatment feedstock 414 with the wood comprised in the wood-sided liquid retainer 416.

It can thus be understood that the vessel assembly 410 can be operated to provide, as selected, an accelerated aging process or a hybrid accelerated aging process/relatively less accelerated aging process and the respective aging process that is selected can be configured to achieve a desired finished liquid product, including a finished liquid product in the form of an alcoholic product such as, for example, a consumable alcoholic beverage.

It is thus contemplated that the treatment feedstock 414 may be in the form of a traditional alcohol-containing liquid that, at the conclusion of the aging process, is a distilled alcoholic beverage such as bourbon, whiskey, cognac, brandy, etc. The treatment feedstock 414 can thus be the type of feedstock often called “liquor.” The process of producing a finished alcoholic product can accommodate any suitable known technique for influencing the composition and flavor of the beverage including techniques for imparting a specified flavor to the treatment feedstock 414, techniques for introducing micro-oxygenation (i.e. small amounts of oxygen) into the treatment feedstock 414 during the aging process, and/or techniques for altering the temperature regime.

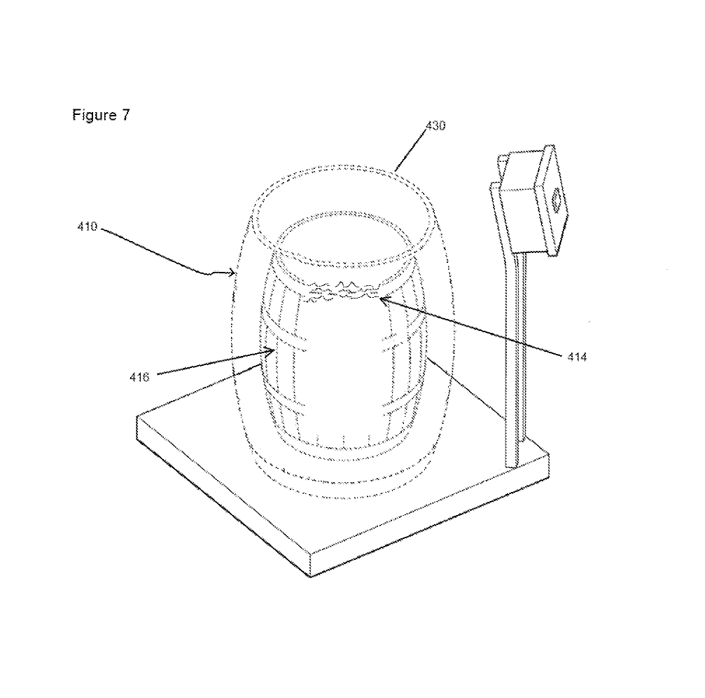

The RF energy delivery assembly 418 includes a co-axial RF emitter 426 that includes an emitter portion extending axially into the wood-sided liquid retainer 416 along the longitudinal axis of the wood-sided liquid retainer 416 and an RF generator 428 operatively coupled to the co-axial RF emitter 426 and located exteriorly of the wood-sided liquid retainer 416. The RF energy delivery assembly 418 additionally includes a component compatibly configured with respect to the co-axial RF emitter 426 such that RF energy is purposefully distributed in the wood-sided liquid retainer 416. An example of such a compatibly configured component is a component that encircles the wood-sided liquid retainer 416, such as a jacket structure. As seen in FIG. 7, which is a schematic top perspective view of the wood-sided liquid retainer 416, a jacket structure 430 is provided that extends circumferentially around the wood-sided liquid retainer 416 and has an axial length at least as long as the axial length of the sidewall 422 of the wood-sided liquid retainer 416.

The jacket structure 430 may be comprised of a metal, an alloy, or any other material that provides the jacket structure with suitable dielectric properties such that RF energy delivered via the co-axial RF emitter 426 will travel through the feedstock 414 to reach and interact with the walls of the wood-sided liquid retainer 416. The jacket structure 430 can be configured of any suitable geometry and the jacket structure 430 may have an overall shape corresponding to that of the wood-sided liquid retainer 416. The jacket structure 430 may be operatively connected to a suitable ground device (not shown) to ensure safe and error-free operation.

In configurations of the wood-sided liquid retainer 416 wherein the wood-sided liquid retainer 416 is not operated in a manner to automatically maintain pressure within the wood-sided liquid retainer 416 within a prescribed pressure range, the introduction of the RF energy into the treatment feedstock 414 will ordinarily raise the pressure inside the wood-sided liquid retainer 416. One suitable approach for maintaining pressure within the wood-sided liquid retainer 416 within a prescribed pressure range in such circumstances is to cyclically introduce the RF energy into the wood-sided liquid retainer 416 by, for example, cyclically operating the RF energy delivery assembly 418 between a powered or “on” status and a powered off or “off” status. The RF energy delivered by the RF energy delivery assembly 418 can be a low frequency RF energy or a high frequency RF energy and can have a frequency in the range from and between 3 MHz and 915 MHz. If the RF energy delivery assembly 418 is operated at 915 MHz, then the co-axial emitter 426 can be dispensed with.

Although the patent applicant does not wish to be bound by any theory, it may be the case that the RF energy acts on the material of the wood-sided liquid retainer 416—i.e., wood—in a manner that causes the cellular capillaries of the wood to open—or widen and constrict (i.e., expand and contract)—in a different way than these cellular capillaries typically open or widen and constrict during non-accelerated aging processes if this phenomenon is occurring, then the accelerated aging of the treatment feedstock 414 may occur because the treatment feedstock 414 is able to more fully or more rapidly infiltrate the cellular capillaries of the wood and thereby achieve a degree of contact with the wood that allows the treatment feedstock 414 to be beneficiated by the wood of the wood-sided liquid retainer 416 in an accelerated manner.

Upon the completion of the aging process executed in accordance with the present invention, the treatment feedstock 414 has been converted into an alcoholic product that may be ready without further processing to be sold or distributed as a consumable product or that may be further processed and ultimately sold or distributed as a consumable product. The thus-produced alcoholic product may be: (a) an alcoholic beverage produced via the accelerated aging process or the hybrid accelerated aging process/relatively less accelerated aging process of the present invention or (b) an alcoholic concentrate, extract, or infusion produced via the accelerated aging process or the hybrid accelerated aging process/relatively less accelerated aging process of the present invention. In some instances, the alcoholic product may be crafted to possess the same or similar sensory, color, and/or taste characteristics as alcoholic beverages crafted via known aging processes such as, for example, the known aging (non-accelerated) of bourbon or whisky in oak barrels. The treatment feedstock 414 to be subjected to the accelerated aging process of the present invention may be an alcoholic distillate of any suitable proof including a bourbon distillate, a whisky distillate, or another distillate.

As an alternative to relying upon the wood of a wood-sided retainer to beneficiate the treatment feedstock 414, the beneficiating of the treatment feedstock 414 via contact with wood can be accomplished by providing wood in a different form such as, for example, units of wood that are also retained within a wood-sided liquid retainer or a non wood-sided liquid retainer. For example, units of wood in the form of units of oak wood can be used. Moreover, such units of wood can be treated to approximate the characteristics of the charred wood sides that, for example, are found in barrels used for the aging of distillate to produce bourbon. For example, the units of oak wood can be toasted and these units of oak wood can be created via the chipping of oak staves of the type used for barrel making. Hot air toasting or other known toasting methods can be used to treat the units of oak wood prior to placing the units of oak wood in the wood-sided liquid retainer 416. It can be understood that the availability of a non-wood sided liquid retainer for this approach broadens the range of suitable liquid retainers and avoids the costs and/or more complex fabrication that may be required if a wood-sided liquid retainer were to be used. The units of oak wood eliminate the need for a traditional charred wood barrel and so opportunities for larger or smaller interior volumes of the wood-sided liquid retainer 416 can be realized. Furthermore, depending upon the geometries and the numbers of units of oak wood that are deployed, it is possible to expose the treatment feedstock 414 to a greater cumulative surface area of wood, as contrasted with the cumulative surface area of wood of a wood-sided liquid retainer of equal liquid volume. Additionally, the process of the present invention can be used to extend the service life of traditional wood barrels that are no longer able to sufficiently beneficiate a treatment feedstock when deployed for use in known or traditional non-accelerated aging processes.

Mechanical resonance is the tendency of a mechanical system to respond at greater amplitude when the frequency of its oscillations matches the system's natural frequency of vibration (its resonance frequency or resonant frequency) than it does at other frequencies. Mechanical resonators operate by transferring energy cyclically between kinetic energy and potential energy. Various methods of inducing mechanical resonance in a liquid medium such as the treatment feedstock 141 can be deployed to enhance the accelerated aging process of the present invention. For example, mechanical waves can be generated in the treatment feedstock 414 by subjecting an electromechanical element to an alternating electric field having a frequency which induces mechanical resonance (and is below any electrical resonance frequency)

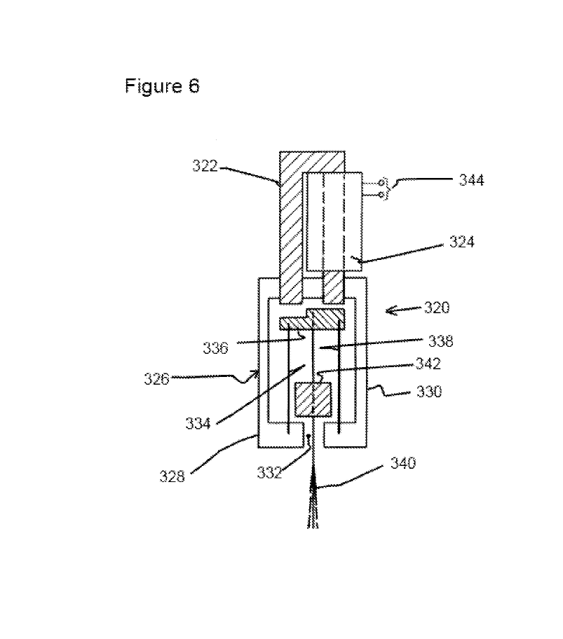

One exemplary embodiment of an electromechanical element for inducing mechanical resonance in the treatment feedstock 414 retained in the wood-sided liquid retainer 416 is shown in FIG. 6, which is a schematic front elevational view of a resonance generator assembly 320. The resonance generator assembly 320 includes an electro magnet having an electromagnetic core 322 and a coil 324. A support frame 326 is secured to the electromagnetic core 322 and the support frame 326 includes a left hand member 328 and a right hand member 330 that delimit between themselves a gap 332. A flat spring 334 has one end secured to the left hand member 328 of the support frame 326 and an opposite end secured to a base plate 336. Another flat spring 338 extends parallel to the flat spring 334 and has one end secured to the right hand member 330 of the support frame 326 and an opposite end secured to the base plate 336.

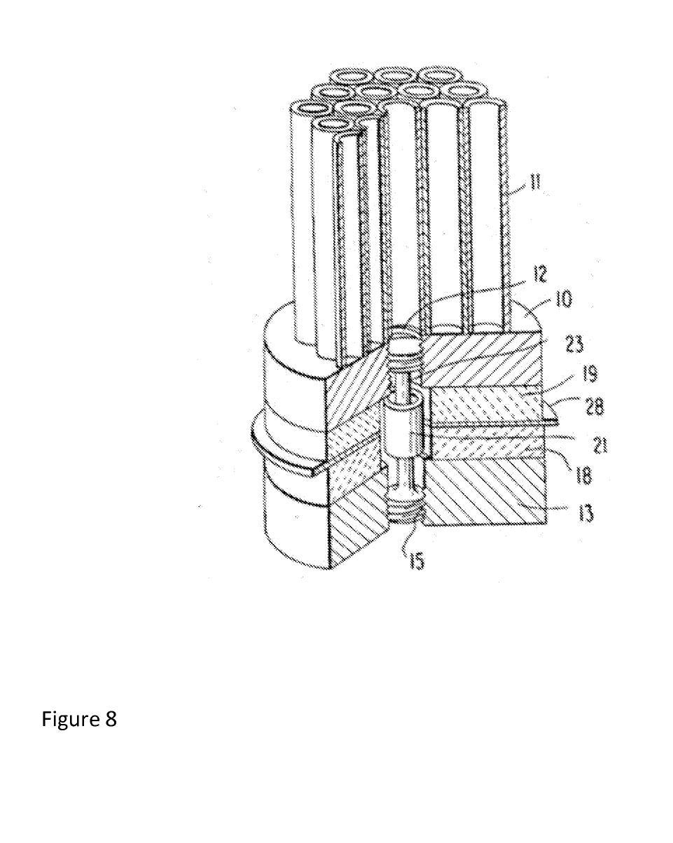

An agitation rod 340 has one end secured to the base plate 336 intermediate the respective locations at which the ends of the flat spring 334 and the flat spring 338 are secured to the base plate 336 and the agitation rod 340 extends through the gap 332 between the left hand member 328 and the right hand member 330 of the support frame 326. A lower portion of the agitation rod 340 is submerged in the treatment feedstock 414 when the resonance generator assembly 320 is disposed in its operating position relative to the wood-sided liquid retainer 416. A dampening mass 342 is secured to the portion of the agitation rod 340 that is intermediate the gap 332 and the base plate 336. A par of terminals 344 connect the coil 324 of the electromagnet to an electrical power source (not shown). The base plate 336 is operatively connected to the electromagnetic core 322 of the electro magnet whereupon, when the coil 324 of the electromagnet is supplied with alternating current via the terminals 344, the thereby-produced alternating magnetic field of the electromagnetic core 322 of the electro magnet generates oscillating movement of the base plate 336 and, accordingly, the agitation rod 342 reciprocally moves in correspondence with this oscillating movement of the base plate 336 and produces mechanical resonance. As seen in FIG. 8, which is a partial sectional top perspective view of a transducer suitable for use in the liquid treatment method of the present invention, an ultrasonic transducer can be optionally provided for generating and transmitting ultrasonic wave energy of a predetermined frequency in the wood-sided liquid retainer 416. The ultrasonic transducer, which can be submerged in the wood-sided liquid retainer 416, acts as a mechanical resonator and includes piezoelectric ceramic material in a transducer stack. The ultrasonic treatment applied by the ultrasonic transducer can beneficially accelerate the chemical reactions that contributed to the accelerated aging process and facilitate the extraction of the flavor or aroma-enhancing components of the wood retained in, or comprised in, the wood-sided liquid retainer 416. The ultrasonic transducer includes a perforated steel plate 10 to which are attached an array of tubes 11. The steel plate 10 has a tapped hole 12 axially thereof. A cylindrical imperforate mass plate 13 has a tapped hole 15 located along its axis. Electrostrictive elements 18, 19 separated by an electrical insulating tube 21 are sandwiched between the mass plates 10 and 13. A stud 21 is threadably secured to the steel plate 10 and the mass plate 13 at the tapped hole 12 and the tapped hole 15, respectively. An assembly of piezoelectric ceramic driver elements or disks consisting of elongated hexagonal members are metallurgically attached by welding or brazing to a plate 28 between the mass plates 10 and 13. It can thus be understood that the method of the present invention provides the opportunity to achieve improved efficiency in connection with the distillation or heating of liquid commodities such as, but not limited to (oil, gas, commercial solvents, ethanol, food additives, water, resins, beer, and liquor). Such improved efficiencies can include: (a) reduction in energy consumption, (b.) reduction in water usage (water is no longer used to create steam for heating), (c.) elimination of natural gas (for heating), (d) improved cycle production times (due to direct heating), (e.) increased system lifespan and reduction in maintenance costs (due to elimination of steam boiler systems natural gas use and longevity of RF generators), and (f.) reduction in equipment footprint (due to elimination of natural gas source). Additionally, opportunities may also exist to realize a reduction in boiler system emissions (due to elimination of steam production) and a reduction in facility ambient temperature (due to boiler system elimination). The method of the present invention additionally provides the opportunity to achieve improved quality control due to (a.) improved heating uniformity (due to heating the mass as a whole) and (b.) improved product temperature control (due to automatic governing control of the computer). There has thus been disclosed one method that includes delivering RF energy through the wave guide that is attached to a quartz window that is on the vessel or on an infeed or load cell location. Additionally, there has been disclosed an alternate method of delivering RF energy for liquid heating through a load cell configuration, which is attached directly to the distillation or cook tank. The liquid can be re-circulated from the vessel through the load cell and back into the vessel, or pumped directly through the load cell into the vessel without re-circulation. The RF energy is attached to the load cell via the wave guide. The load cell, through which the liquid flows, may be comprised of high temperature poly (plastic), glass, quartz or ceramic. The load cell can be any size and/or shape as long as the RF is introduced via a similar method, which may include, but is not limited to, a straight pipe or heat exchanger configuration within a load cell. The load cell technology may be used to alter existing distillation systems as an alternate heat source. The RF introduced into the load cell is controlled by a computer that is governed by data points which are collected from sensors that may communicate information via analog, digital, fiber optic or infrared, which controls the decision to automatically or manually adjust the RF power output into the load. The vessel will also include similar broad range of sensors to communicate information to the computer in order to govern the distillation process. The vessel may or may not have agitation. The exemplary shapes, dimensions, and materials described herein are provided by way of example only. Liquid containment vessels fabricated in shapes, dimensions and using different infeeds and outlets and materials and having a different manner of operation other than those discussed and illustrated herein also are contemplated. It is to be realized that the optimum dimensional relationships for the parts of the invention, to include variations in size, materials, shape, form, function and manner of operation, assembly and use, are deemed readily apparent and obvious to one skilled in the art. Additionally, it is understood that the present disclosure of the preferred forms is only by way of example and that numerous changes in the details of operation and in the combination and arrangement of parts may be resorted to without departing from the spirit and scope of the invention as hereinafter claimed. The vessel box 252 can alternatively be formed of a fluorocarbon polymer with nonsticking properties such as a polytetrafluoroethylene sold under the registered trademark Teflon in lieu of a glass, quartz, ceramic or other glass or material.

It is claimed:

1. A method for assisting in the distillation or heating of a liquid commodity, the method comprising:
providing a liquid commodity; and
irradiating the liquid commodity directly with radio frequency energy.

2. The method according to claim 1, wherein the radio frequency energy is at a frequency at or about 915 MHz.

3. The method according to claim 1, wherein the temperature of the liquid commodity is increased between about 25 degrees Fahrenheit end about 150 degrees Fahrenheit while the liquid commodity is being subjected to the radio frequency energy.

4. The method according to claim 1, wherein the liquid commodity is subjected to the radio frequency energy for at least about one hour.

5. The method according to claim 1, wherein the liquid commodity is subjected to the radio frequency energy for between about one and about six hours.

6. An apparatus for assisting in the distillation or heating of liquid commodities, the apparatus comprising:
a vessel for retaining a liquid commodity;
and
a device for irradiating the liquid commodity directly with radio frequency energy.

7. The apparatus according to claim 6, wherein the radio frequency energy is at a frequency at or about 915 MHz.

8. The apparatus according to claim 6, wherein the apparatus is operable to increase the temperature of the liquid commodity between about 25 degrees Fahrenheit and about 150 degrees Fahrenheit.

9. The apparatus according to claim 6, wherein the apparatus is operable to subject the liquid commodity to the radio frequency energy for at least about one hour.

10. The apparatus according to claim 6, wherein the apparatus is operable to subject the liquid commodity to the radio frequency energy for between about one and about six hours.

11. The apparatus according to claim 6, wherein the vessel is a load cell sub-assembly and includes an infeed from receiving a supply of liquid from a distillation tank or cook tank, the load cell sub-assembly being operable to receive liquid from a distillation tank or cook tank and to heat the liquid via radio frequency energy to generate vapor, and the load cell sub-assembly including sensors in communication with a control device via one or more analog, digital, fiber optic, or infrared connections and the sensors operating to provide signals to the control device indicating sensed parameters of the process such that the control device can automatically or with user input control and adjust the radio frequency power output.

12. A consumable liquid product formed by the process of:
providing a liquid commodity; and
irradiating the liquid commodity directly with radio frequency energy.
